(19) United States
(12) Patent Application Publication
(10) Pub. No.: US 2005/0176465 A1
(43) Pub. Date: Aug. 11, 2005

(54) Automatic mobile device configuration system and method in a mobile communication network

(75) Inventor: Peter Fornell, Lake Oswego, OR (US)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/774,809

(22) Filed: Feb. 9, 2004

(51) Int. Cl. H04Q 7/20

(52) U.S. Cl. 455/558; 455/551

(57) ABSTRACT

A method of configuring a mobile device in a mobile communications network comprises determining whether a first identity module coupled to a mobile device is different from a second identity module previously coupled to the mobile device; searching entries in a data structure for first configuration data associated with the first identity module; and configuring the mobile device to use the first configuration data.

### BACKGROUND

1. Field of Invention

The present invention relates generally to mobile communication devices and, more particularly, to a system and method for automatically configuring a mobile device receiving a new identification module for communicating in a mobile communications network.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Global System for Mobile Communications (GSM) is a digital cellular phone technology based on Time Division Multiple Access (TDMA). GSM defines the air interface technology (e.g., IDMA) along with the entire cellular communications network. Presently, GSM enabled mobile devices require a Subscriber Identity Module (SIM) to be operational. An identity module or the SIM is a smart card that contains user account information.

A mobile device is automatically programmed with the user account information stored in the SIM when the SIM is inserted. A SIM can be also programmed, for example, to display custom menus for personalized services. This allows for the mobile device to be easily rented or lent to a new user. The new user, generally, will only have to insert his or her SIM card in the mobile device to reprogram the mobile device with the user's personal account information.

Unfortunately, however, personal account information in certain cases are not sufficient to make the mobile device operational. This is because most service providers or communication operators require that a mobile device to be also programmed with communications network's access or configuration data for a particular operator. Such configuration data includes network access data such as, for example, an access point name (APN), a wireless access point internet protocol (WAP IP) address, a web gateway IP address, a short messaging service center (SMSC), system identification code (SID), and other system or environment dependent codes.

Some configuration data is stored in the SIM card while other configuration data is stored in the mobile device's internal memory. Therefore, if a newly inserted SIM complies with an operator network or service provider requirement that is different from the previously inserted SIM, then the old configuration data associated with the previous identity module will not work with the newly inserted one.

For example, if a Vodaphone SIM card in a mobile device is later replaced with a SIM card for access to T-Mobile networks, then Vodaphone configuration data stored in the mobile device's memory would have to be replaced with configuration data for T-Mobile. As such, when a new SIM card is inserted into a mobile device, the configuration data for a new operator or service provider will have to be actively programmed in the mobile device either manually or by the operator.

The configuration data is essential for successfully providing the needed services to a subscriber using the mobile device. Environment related data is used by the communications network systems and the mobile device to identify, process and route communication signals. Any change or mistake in storing said data in the mobile device can result in an interruption of service or improper operation of the mobile device.

Accordingly, it is important for the configuration information to be correctly and easily programmed in the mobile device when a new identity module or SIM card is coupled to the mobile device. The configuration information often is not available to an ordinary subscriber. Furthermore, most subscribers are not technically inclined to program a mobile device, even if they have the configuration information. Particularly because interacting with the programming menus can prove to be tedious even for a technically savvy subscriber.

For the above reasons, a method and system is needed that can transparently reconfigure a mobile device when a new identity module is coupled to it.

### SUMMARY

A method of configuring a mobile device in a mobile communications network is provided. The method comprises determining whether a first identity module coupled to a mobile device is different from a second identity module previously coupled to the mobile device; searching entries in a data structure for first configuration data associated with the first identity module; and configuring the mobile device to use the first configuration data, when said first configuration data is present in an entry of the data structure, wherein the data structure has a plurality of entries that comprise configuration data for respective plurality of identity modules that can be coupled to the mobile device.

In some embodiments, the method further comprises prompting entry of the first configuration data, when the first configuration data is not present in an entry of the data structure; storing the first configuration data in a first entry in the data structure, in response to receiving said first configuration data; and storing a reference to the first identity module in a second entry in the data structure, wherein the first entry is associated with the second entry, such that when the first identity module is recoupled to the mobile device after being removed, the reference in the second entry is used to access the first configuration data stored in the first entry, wherein the data structure is stored in a memory module in the mobile device or in a communications network component accessible by the mobile device.

In one embodiment, the data structure is in a table format with entries that associate at least one identity module with respective configuration data for said at least one identity module. The first configuration data comprises a mobile communication network access point name (APN) or a wireless application protocol internet protocol (WAP IP) address.

In another embodiment, the method of configuring a mobile device coupled to a first identity module comprises detecting a second identity module coupled to the mobile device after the first identity module; searching a first entry in a data structure for network access information associated with the second identity module; and configuring the mobile device according to the network access information in the first entry to allow the mobile device to operate in a mobile communications network using the second identity module without need for externally programming the mobile device with the network access information.

The data structure accommodates multiple entries for storing multiple network access information corresponding to multiple identity modules configured for coupling with the mobile device. The detecting comprises identifying the second identity module based on a second unique value embedded in the second identity module; and comparing said second unique value with a first unique value embedded in the first mobile identity module to detect if said first and second unique values match. In one embodiment, the second unique value is a serial number of the second identity module. In another embodiment, the second unique values is a network ID associated with the second identity module.

In accordance with yet another embodiment, a mobile device in a mobile communications network comprises means for determining whether a first identity module coupled to the mobile device is different from a second identity module previously coupled to the mobile device; means for searching entries in a data structure for first configuration data associated with the first identity module; and means for configuring the mobile device to use the first configuration data, when said first configuration data is present in an entry of the data structure, wherein the data structure has a plurality of entries that comprise configuration data for a corresponding plurality of identity modules implemented for coupling with the mobile device.

The mobile device may further comprise means for prompting entry of the first configuration data, when the first configuration data is not present in an entry of the data structure; means for storing the first configuration data in a first entry in the data structure, in response to receiving said first configuration data; and storage means for storing the data structure.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of an automatic method for updating configuration data of a mobile device, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

Electronic systems and corresponding methods, according to an embodiment of the present invention, are provided to facilitate configuring a mobile communication device when an identity module is coupled to the mobile device.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

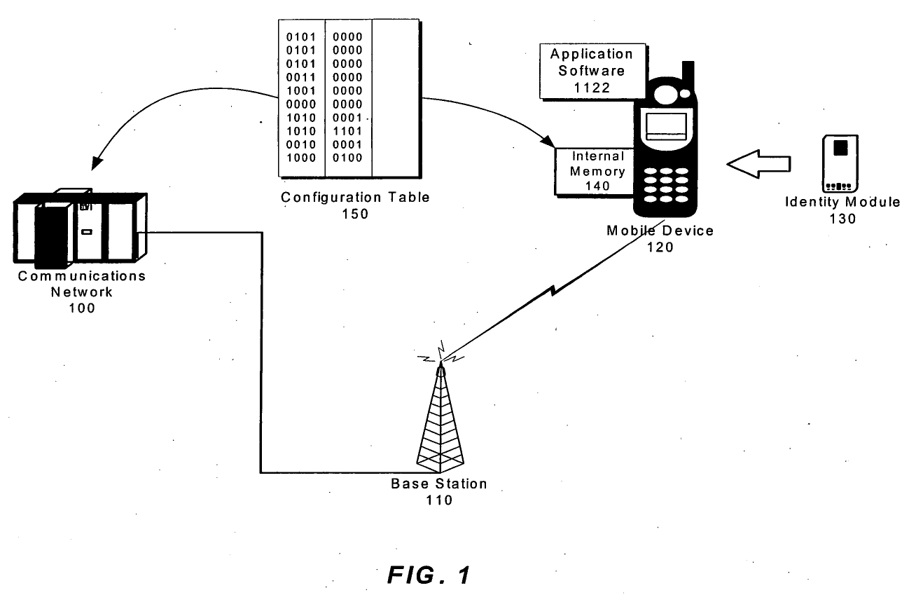

Referring to the drawings, FIG. 1 illustrates an exemplary communications environment in which the system of the present invention may operate. In accordance with one aspect of the system, the environment comprises a communications network 100, a base station 110, a mobile device 120, an identity module (e.g., SIM card) 130, and internal memory 140, and a configuration table 150, for example.

Communications network 100 may be connected to database centers or include storage devices, for example, to update and store, among other information, configuration data received from mobile device 120. The terms “connected,” “coupled,” or any variant thereof, mean any connection or coupling, either direct or indirect, between two or more elements. The coupling or connection between the elements can be physical, logical, or a combination thereof.

In one embodiment, service provider (not shown) communicates with mobile device 120 connected to the communications network 100. The communications environment illustrated in FIG. 1 provides the medium and infrastructure for transmitting digital or analog signals between the telephony operators (not shown) and mobile device 120. In certain embodiments, mobile device 120 is a wireless cellular telephone, for example.

Furthermore, communications network 100 may be a cellular telephony network operated by, for example, T-Mobile, Orange, Vodaphone or other cellular system operators. Mobile device 120 and the communications network 100, however, may be implemented over any type of mobile, fixed, wired or wireless communication system as provided below.

For example, one of ordinary skill in the art will appreciate that the communications network may advantageously be comprised of one or a combination of various types of networks such as local area networks (LANs), wide area networks (WANs), public, private or secure networks, value-added networks, interactive television networks, wireless communications networks, two-way cable networks, satellite networks, interactive kiosk networks, optical networks, personal mobile gateways (PMGs) and/or any other suitable communications network or segment of the world wide web (i.e., the Internet).

In either context, mobile device 120 can communicate with communications network 100 to send and receive electronic packets of information, in form of electronic requests and responses. Some of the services provided by the system of the present invention may be implemented as application software 1122 installed and executed on mobile device 120, as provided in further detail below. In certain embodiments, application software 1122 executed on mobile device 120 can act as client software that is in communication with communications network 100 or a wireless telephony operator, for example.

In some embodiments, mobile device 120 may comprise a PMG device or communicate with a PMG device. The PMG architecture comprises a PMG server that can wirelessly communicate with a number of PMG enabled devices within the personal area of the user, thus providing a personal area network (PAN).

In addition, the PMG server can wirelessly communicate with remote server systems, such as a service provider, via a wireless system or communications network 100 in a WAN. Thus, the PMG acts as an interface to seamlessly connect a PAN to a WAN, and as such the devices attached to the PAN or WAN can communicate with each other. A more detailed description of the PMG architecture is provided in U.S. patent application Ser. No. 09/850,399, filed on May 7, 2001, the entire content of which is hereby incorporated by reference here.

As used herein, the terms service provider, telephony operator and communications network are to be viewed as designations of one or more computing environments that comprise application, client or server software for servicing requests submitted by respective software included in mobile devices or other computing systems connected thereto. These terms are not to be otherwise limiting in any manner. The application software 1122, for example, may be comprised of one or more modules that execute on one or more computing systems, in a distributed environment.

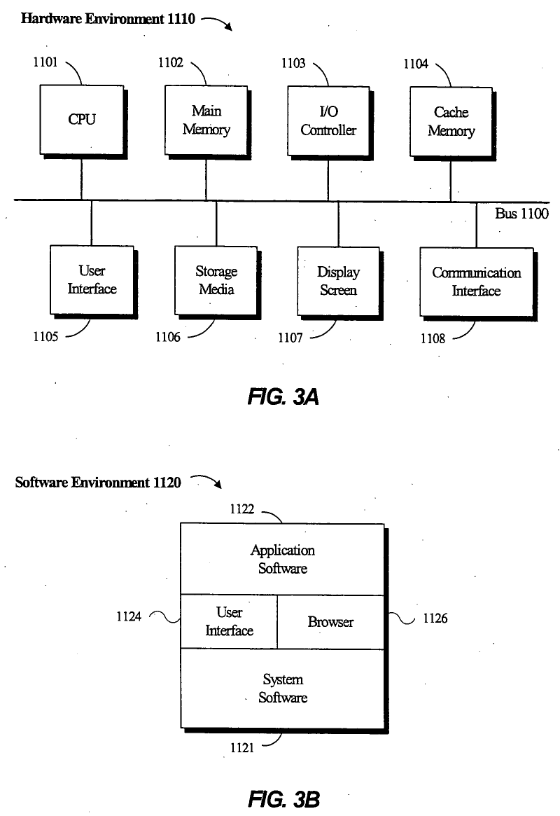

Referring to FIGS. 1 and 3A, in accordance with one aspect of the invention, application software 1122 is implemented on mobile device 120, for example, to configure mobile device 120 when a user replaces the mobile device 1120's identity module 130. To accomplish this, application software 1122 searches a configuration table 150 for configuration data associated with newly inserted identity module 130. If configuration data is stored in configuration table 150, then application software 120 stores the data in internal memory 140.

In other embodiments, application software 1122 is capable of communicating with a third party system, such as communications network 100, or a PMG device to store configuration data for mobile device 120 in a storage device other than internal memory 140. For example, application software 1122, in some embodiments, may communicate with communications network 100, either directly or through a proxy server, to store or retrieve configuration data. That is, in certain embodiments, configuration table 150 can be stored either in internal memory 140 or on external storage devices accessible through communications network 100.

It should be noted, however, that the exemplary embodiments disclosed above are not to be construed to limit the scope of the invention to application software that is exclusively executed on mobile device 120, or a system that exclusively operates to provide real time support to update mobile device configuration data. Other data may be also updated based on the technology that is the subject matter of this invention.

In some embodiments, application software 1122 may be implemented on a device or system other than mobile device 120. For example, application software 1122 or its components may be implemented, installed, and executed either in a singular or in a distributed environment. Certain components of the application software 1122 may be installed and executed on mobile device 120 while other components may be executed and installed on, for example, a PMG device, communications network 100, internet portals, service provider server systems, or other computer systems and networks attached thereto.

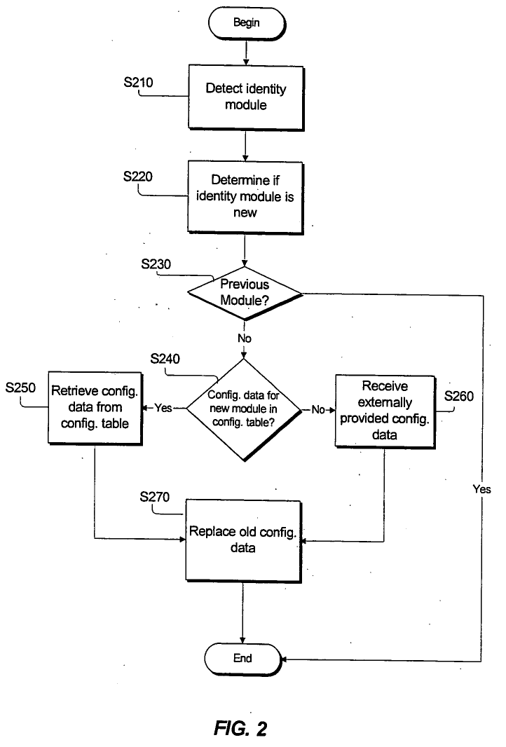

Referring to FIGS. 1 and 2, in accordance with one aspect of the invention, when an identity module 130 is inserted or coupled to mobile device 120, certain configuration data and user account information are programmed or stored in mobile device 120's internal memory. The configuration data comprises a variety of information related to processing, routing and timing of communication data between mobile device 120, base station 110, and communications network 100.

When a new identity module 130 is inserted in mobile device 120, some of the configuration data stored in mobile device 120 need to be updated so that the new identity module 130 can properly operate. For example, the new identity module 130 may operate according to a different APN or WAP IP address, in comparison to the previously installed identity module. Accordingly, replacing identity module 130 in mobile device 120 requires updating such configuration data.

Referring to FIG. 2, application software 1122 is implemented to detect the insertion of identity module 130 into mobile device 120 (S210). Application software 1122 then determines whether identity module 130 is a new identity module (S220). That is, application software 1122 verifies whether identity module 130 has been previously coupled to mobile device 120.

For verification, application software 1122 may retrieve unique identifying information available on identity module 130. If the identity module is a SIM card, for example, the unique identifying information may be embedded on the SIM as a manufacturer serial number. Another possible unique identifier may include a network ID assigned to the identity module 130.

In some embodiments, application software 1122 stores the unique identifying information in memory 140 or in configuration table 150. Thus, if identity module 130 has been previously coupled to mobile device 120, then application software 1122 will find the unique identifying information after searching configuration table 150 for that information.

If it is determined that identity module 130 is the same as the previous identity module coupled to mobile device 120, then configuration data stored in internal memory 140 need not be changed (S230). That is, mobile device 120's configuration will remain the same, if the previous identity module is reinserted in mobile device 120.

If another identity module 130 is coupled to mobile device 120, however, mobile device 120 needs to be reconfigured (S230). Referring back to FIG. 1 and FIG. 2, application software 1122 searches configuration table 150 to determine if configuration data for the new identity module 130 is stored in configuration table 150 (S240).

In one embodiment, configuration table 150 comprises configuration data associated with some or all identity modules 130 that have been previously coupled to mobile device 120. That is, in accordance with one aspect of the invention, each time a new identity module 130 is coupled to mobile device 120, application software 1122 stores the respective configuration data in configuration table 150 in association with the unique identifying information for that identity module, such that if the identity module 130 is reinserted, the configuration data for the identity module 130 can be retrieved from configuration table 150 (S250).

In other embodiments, configuration table 150 may be pre-configured to comprise configuration data for any possible identity module 130 that can be coupled to it. For example, configuration table 150 may comprise configuration data associated with various mobile operators such as T-Mobile, Orange, Vodaphone, etc. In certain embodiments, said configuration data may be retrieved from alternative resources (e.g., databases) connected to communications network 100, if such data is not stored in configuration table 150, for example, or if configuration table 150 is inaccessible.

If configuration data for the inserted identity module 130 is stored in an entry of the configuration table 150, then application software 1122 will retrieve the respective configuration data and store it in internal memory 140 of mobile device 120 to replace the old configuration data (S250, S270). In certain embodiments, configuration data may be stored on other memory storage media or chip that holds its content with or without power (e.g., Electrically Erasable Programmable ROM (EEPROM), Flash Memory, Memory Stick, etc.).

If application software 1122 fails to retrieve configuration data for the new identity module 130 from configuration table 150, then configuration data will have to be provided by an external source. In one embodiment, for example, application software 1122 may prompt the user to enter such data or alternatively access a database of a service provider or a respective telephony operator to retrieve the configuration data (S260).

In accordance with one aspect of the invention, a user may touch enter the configuration data for identity module 130 into mobile device 120. When the configuration data is received (S260), application software 1122 replaces the old configuration data stored, for example, in internal memory 140 with the newly provided configuration data (S270).

Certain embodiments of the invention are designed such that configuration data associated with various identity modules is orderly stored in a configuration table 150 so that such data is available for future retrieval. Configuration table 150 may be implemented in form of a data structure with entries to store the configuration data in association with a number (e.g., serial number, network ID, etc.) that uniquely identifies identity module 130, or a telephony operator, for example.

Entries in configuration table 150 (e.g., serial number, network ID) may be searched to determine if an inserted identity module has been previously coupled to mobile device 120. When the unique identifier is found, then entries in configuration table 150 associated with the respective entry are queries to retrieve the corresponding configuration data for the identity module 130.

Configuration table 150, in one embodiment, may comprise a plurality of records and data structures that are implemented in relationship with one another to track and reference configuration data for various identity modules 130 associated with various telephony operators. Accordingly, based on the above implemented configuration procedure, a mobile device 120 may be automatically reconfigured by referring to data stored in configuration table 150.

Furthermore, alternative configuration procedures may be implemented in accordance with other embodiments. For example, in one embodiment, the configuration procedure may require the user to insert a memory card having configuration data for a newly inserted identity module 130. In other embodiments, the new configuration data may be accessible by way of the user or application software 1122 accessing a configuration database over the internet, using a browser software installed on mobile device 120, for example. Thus, in certain embodiments, configuration data may not be directly accessible from internal memory 140.

In one embodiment, application software 1122, or other software in communication therewith, performs a verification process to determine that the new configuration data can be properly utilized to reconfigure mobile device 120. Accordingly, the configuration data is compared to a range of values. If it is determined that the configuration data is out of range, then an alert signal or message is produced to notify the user, for example. In such scenario, the user may be given the option to enter the configuration data or restore the system settings to its default or previous value.

In certain circumstances, application software 1122 is implemented to detect a corruption in configuration data and automatically correct the corruption. A customer service representative, for example, may be contacted to make a decision on how to solve the problem associated with the corruption.

In some embodiments, the system may automatically or in conjunction with a human operator configure the appropriate data in mobile device 120, by way of remote signal transmission. Thus, configuration data for mobile device 120 can be updated, verified, and reset either automatically or manually in accordance with one or more methods provided herein.

In embodiments of the invention, mobile device 120, base station 110, communications network 100, configuration table 150, application software 1122 and identity module 130 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task such as detecting insertion of a new identity module 130 and reconfiguring mobile device 120 with corresponding configuration data.

Referring to FIG. 3A, an embodiment of the application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a blue tooth port, a modem, or an integrated services digital network (ISDN) card, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless mobile device (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows CE, Microsoft Windows NT, Macintosh OS, or IBM OS/2. However, any other suitable operating system may be utilized.

Application software 1122 can comprise one or more computer programs that are executed on top of system software 1121 after being loaded from storage media 1106 into memory 1102. In client-server architecture, application software 1122 may comprise client software and server software. Referring to FIG. 1 for example, in one embodiment of the invention, client software is executed on mobile unit 110 and server software is executed on the service provider system (not shown) or support center 170.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate updating configuration data of a mobile device stored in a service provider's database. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of configuring a mobile device in a mobile communications network, the method comprising:
determining whether a first identity module coupled to a mobile device is different from a second identity module previously coupled to the mobile device;
searching entries in a data structure for first configuration data associated with the first identity module; and
configuring the mobile device to use the first configuration data, when said first configuration data is present in an entry of the data structure,
wherein the data structure has a plurality of entries that comprise configuration data for respective plurality of identity modules that can be coupled to the mobile device.

2. The method of claim 1, further comprising:
prompting entry of the first configuration data, when the first configuration data is not present in an entry of the data structure.

3. The method of claim 2, further comprising:
storing the first configuration data in a first entry in the data structure, in response to receiving said first configuration data.

4. The method of claim 3, further comprising:
storing a reference to the first identity module in a second entry in the data structure, wherein the first entry is associated with the second entry, such that when the first identity module is recoupled to the mobile device after being removed, the reference in the second entry is used to access the first configuration data stored in the first entry.

5. The method of claim 1, wherein the data structure is stored in a memory module.

6. The method of claim 1, wherein the data structure is stored in the mobile device.

7. The method of claim 1, wherein the data structure is stored in a communications network component accessible by the mobile device.

8. The method of claim 4, wherein the data structure is in a table format with entries that associate at least one identity module with respective configuration data for said at least one identity module.

9. The method of claim 1, wherein the first configuration data comprises a mobile communication network access point name (APN).

10. The method of claim 1, wherein the first configuration data comprises a wireless application protocol internet protocol (WAP IP) address.

11. A method of configuring a mobile device coupled to a first identity module, the method comprising:
detecting a second identity module coupled to the mobile device after the first identity module;
searching a first entry in a data structure for network access information associated with the second identity module; and
configuring the mobile device according to the network access information in the first entry to allow the mobile device to operate in a mobile communications network using the second identity module without need for externally programming the mobile device with the network access information.

12. The method of claim 11, wherein the data structure accommodates multiple entries for storing multiple network access information corresponding to multiple identity modules configured for coupling with the mobile device.

13. The method of claim 11, wherein the detecting comprises:
identifying the second identity module based on a second unique value embedded in the second identity module; and
comparing said second unique value with a first unique value embedded in the first mobile identity module to detect if said first and second unique values match.

14. The method of claim 13, further comprising:
determining that the second identity module is other than the first identity module, when the first and second unique values do not match.

15. The method of claim 13, wherein the second unique value is a serial number of the second identity module.

16. The method of claim 13, wherein the second unique values is a network ID associated with the second identity module.

17. A mobile device in a mobile communications network, the mobile device comprising:
means for determining whether a first identity module coupled to the mobile device is different from a second identity module previously coupled to the mobile device;
means for searching entries in a data structure for first configuration data associated with the first identity module; and
means for configuring the mobile device to use the first configuration data, when said first configuration data is present in an entry of the data structure,
wherein the data structure has a plurality of entries that comprise configuration data for a corresponding plurality of identity modules implemented for coupling with the mobile device.

18. The mobile device of claim 17, further comprising:
means for prompting entry of the first configuration data, when the first configuration data is not present in an entry of the data structure.

19. The mobile device of claim 18, further comprising:
means for storing the first configuration data in a first entry in the data structure, in response to receiving said first configuration data.

20. The mobile device of claim 17, further comprising:
storage means for storing the data structure.
